(19) United States
(12) Patent Application Publication
(10) Pub. No.: US 2011/0126250 A1
(43) Pub. Date: May 26, 2011

(54) SYSTEM AND METHOD FOR ACCOUNT-BASED STORAGE AND PLAYBACK OF REMOTELY RECORDED VIDEO DATA

(76) Inventor: Brian Turner, Incline Village, NV (US)

(21) Appl. No.: 13/019,072

(22) Filed: Feb. 1, 2011

Related U.S. Application Data
(63) Continuation-in-part of application No. 11/819,206, filed on Jun. 26, 2007.

(51) Int. Cl. H04N 7/173

(52) U.S. Cl. 725/109

(57) ABSTRACT

A user interacts with a data storage service which enables one or more feeds from video and or web cameras to be streamed to the data storage service. The data storage service then provides storage and/or playback services to the subscriber (e.g., for a monthly fee or a usage fee). Once the video streams have been established between at least one camera and the data storage facility, the user may access the recorded data from any one of several sources, such as a world wide web browser or a cellular phone). The interface may provide a matrix of displays such that the user can see multiple areas or multiple parts of the same area simultaneously.

### CROSS-REFERENCE TO RELATED APPLICATION

This application claims is related to and is a continuation-in-part of co-pending U.S. patent Ser. No. 11/819,206, filed Jun. 26, 2007, naming Brian Turner as an inventor, the contents of which are incorporated herein by reference.

### FIELD OF INVENTION

The present invention is directed to a method and system for assembling real-time and non-real-time information sources, and in one embodiment to a method and system for integrating real-time recording of video from at least one of a camera and a web camera and playback from a remote storage system.

### DISCUSSION OF THE BACKGROUND

As the available bandwidth on the Internet grows, additional services are now being provided which previously were impractical or impossible from a bandwidth perspective. However, it is now possible to conduct not only video conferencing but real-time recording of video for security purposes. However, in some circumstances, most of the time the recorded video has little value (e.g., when recording a remote location where nothing is occurring). It is only when an important even occurs (e.g., the remote location is broken into), that the video needs to be reviewed. As a result, it is not necessarily economical to require each company that wishes to record video to have its own expensive video storage and playback facility.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exemplary screenshot of a World Wide Web interface for controlling a first video stream;

FIG. 2 is an exemplary screenshot of a World Wide Web interface for controlling first and second video streams;

FIG. 3 is an exemplary screenshot of a World Wide Web interface for controlling first and second video streams which alternate in the same video window;

FIG. 4 is a block diagram of a system for viewing remotely stored video data recorded at plural remote sites;

FIG. 5 is a ladder diagram showing messages between various components in the system;

FIGS. 6A and 6B are bloom patterns used in determining if motion exists between corresponding pixels of consecutive video frames;

FIGS. 7-10 are exemplary graphical user interfaces for creating access lists associated with an account such that the permissions of various users associated with an account can be specified;

FIG. 11 is a block diagram showing various communications channels in a communication session between a client and a Data Management Service;

FIG. 12 is a flowchart illustrating a prioritized communication system for providing priority to system channel data over video channel data;

FIG. 13 is a block diagram showing network sessions between various components of a system such as the system shown in FIG. 4;

FIG. 14 is a ladder diagram showing messages between components in the system to support creation of a downloadable video clip; and

FIGS. 15A and 15B are a ladder diagrams showing messages between various components in the system during video recording and video playback, respectively.

### DETAILED DESCRIPTION

According to one aspect of a system described herein, a user subscribes to a data management service which enables one or more feeds from a video camera and or a web camera or other device defined within the data management service to be streamed to the data management service. The data management service then provides storage, playback, and/or event trigger services to the subscriber (e.g., for a monthly fee or a usage fee). In this way the subscriber does not need to have the storage to save the video nor does it need the backup services required to protect the stored video from loss, nor does it need to have a programmed data interaction facility to generate triggered actions or events from the streamed data.

When storing the video from at least one video camera or web camera, the data management service may be requested to playback video from an earlier time or generate a triggered action in addition to continuing to record. The recording, playback, and event generation therefore compete for network utilization. The real-time data stream can be lost if it is not captured as it is being recorded, or a critical triggered event may be missed. However, if the playback becomes slower, then there is no information loss, just unresponsiveness and/or choppiness. As a result, the communications protocol is preferably designed such that event generation and data recording are provided a greater priority than playback. For example, if an alarm at a remotely monitored facility causes a user to receive an e-mail, the user may wish to see why the alarm occurred, but it is more important to continue to send immediate notifications and to record the conditions that caused the alarm.

To this end, a user arranges for data management with a data management facility. For example the data management facility may charge a fee to the user for every camera that is connected, for a given number of triggered events, for a set amount of data to be recorded, or for a number of users who may have live interaction with the data streams. Alternatively, the data management facility may not charge a fee for interaction but instead provide advertisements on the screen while the video is being played back or other data streams are being monitored. Furthermore, the fees for storage, playback, and event generation may be combined or separate.

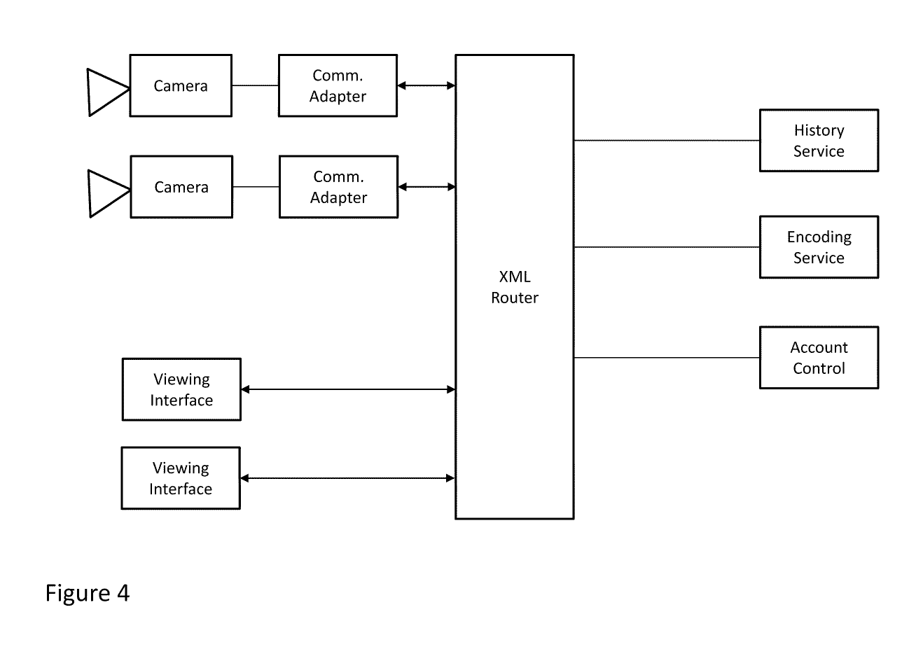

As shown in FIG. 4, the user then connects user-side camera systems to the data storage facility, either by pushing the video data to the data storage facility or by allowing the data storage facility to pull the data by accessing a user-side camera system (e.g., a camera with integrated software or a video server computer to which one or more cameras are attached). Cameras may be connected to a video server computer through a standard interface (e.g., a USB interface) or through custom hardware (e.g., a video capture board). It should be understood that in embodiments using a camera with integrated software, a server may be inside the camera itself. Alternatively, there may be a video server computer or other specialized data aggregating device that aggregates the video data from several cameras (e.g., connected to various USB ports of the same computer) before passing them on to the data storage facility.

The data storage facility includes wired and/or wireless communications adapters (e.g., WiFi adapters, Ethernet adapters, WiMax adapters, telephone line adapters such as modems) for receiving and transmitting the video data from/to the cameras and the users. Such communications adapters may use any unreliable or reliable transmission protocol (e.g., UDP/IP or TCP/IP). The data storage facility also includes computer storage devices (e.g., hard disks, hard disk arrays and optical disks and/or arrays) for storage of the video data. The data storage facility further includes a command interpreter for interpreting the requests from the user which specify how the video data is to be played back to the user.

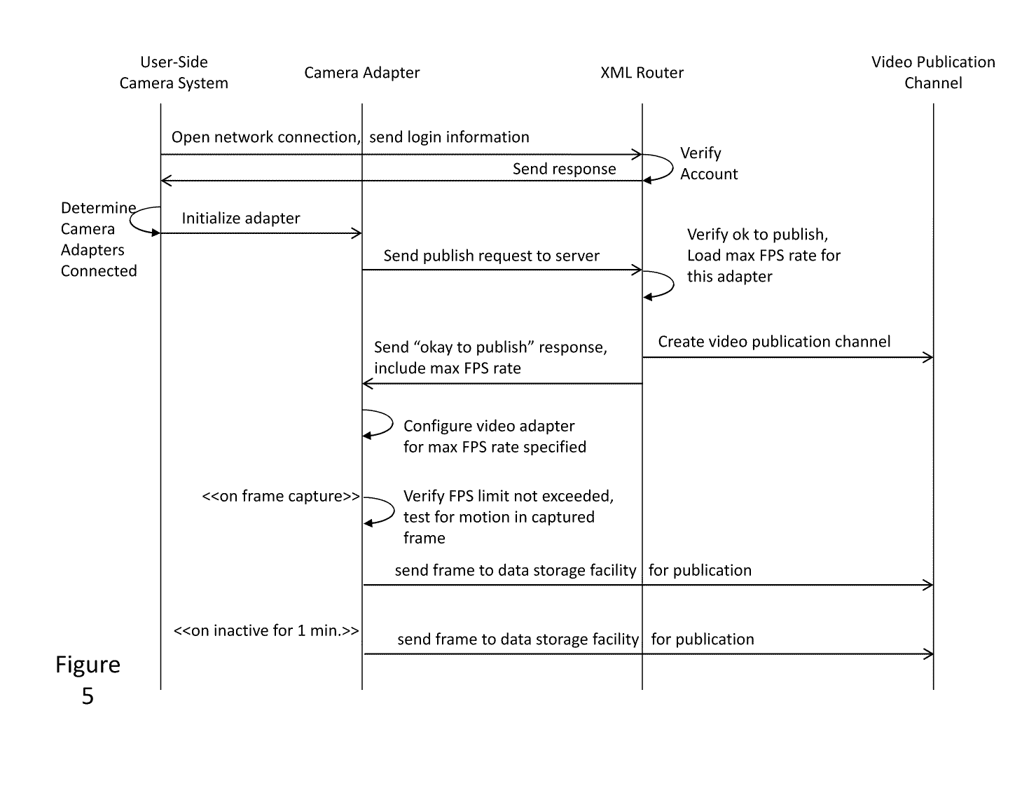

As part of (virtually) connecting the camera(s) to the data storage facility (as described above), a number of messages are sent between the various components of the system, as shown in FIG. 5. When the user-side camera system is powered on and the video server software is loaded, the user-side camera system opens a network connection to at least a portion of the server equipment (e.g., to a server acting as an XML router). The user-side camera system sends a login request to the XML router, including the customer account that the user-side camera system is running under and the password. The XML router will authenticate that the account exists and the password is valid and then return a response to the user-side camera system indicating that login was successful. The network connection that was opened remains open for as long as the user-side camera system is powered on. This network connection is referred to as the system channel, and it is used by the user-side camera system and the XML router to send protocol messages back and forth.

After the connection is established, the user-side camera system verifies that each video adapter is still connected and working properly, and then, for each video adapter, it sends a publication request (including a unique identifier) to the XML router over the system channel. This request tells the XML router which video adapter (identified by a unique identifier) is requesting the rights to publish a video feed. The XML router validates that this video adapter is authorized to publish video, subject to limitations on the number of video feeds that are allowed by the customer's subscription plan. The XML router also looks at the customer's account information to determine the maximum frames per second (FPS) rate that is allowed for this video adapter. The XML router has the ability to control the FPS rate for each of the customer's video adapters individually using account configuration values that are stored in the administrative database. The XML router sends a response back to the user-side camera system indicating that publishing a video feed is OK. This response includes the maximum FPS rate that the video adapter is allowed to capture video.

The user-side camera system initializes each video adapter, and configures the video drivers to capture video at the maximum FPS rate specified in the response from the XML router for each video adapter. A secondary communication channel is opened (a “video publication channel”) between each video adapter and the XML router. The purpose of this channel is to transport video frames to the XML router. Transporting these frames across a secondary channel allows protocol messages to continue to be exchanged across the system channel without experiencing any delay due to high network traffic.

After each video adapter is initialized, it enters into a continuous loop that will continue to run for as long as the user-side camera system is active. Each time a frame is captured from the video device, the video adapter first checks to make sure that frames are being received from the adapter at a speed less than or equal to the maximum FPS rate specified by the XML router. This is a secondary check to ensure that the maximum FPS setting is respected even in cases where the driver does not support FPS throttling. If frames are received faster than allowed, they are ignored. Following this FPS speed test, the video adapter preferably uses a motion detection algorithm to determine if motion was detected between the incoming frame and the previous frame that was sent to the XML router. This is a bandwidth saving feature that prevents the sending of redundant frames to increase performance and reduce network usage. If motion was detected, the frame is sent across the video publication channel to the XML router for distribution to clients that are subscribed to this video feed.

To keep the network connection active, each video adapter will send frames to the server occasionally (e.g., at a rate of not less than one frame per minute), even if no motion is detected in the frames that are captured by the device.

Even in cases where no motion exists between two frames captured by the video device, two frames will never match exactly. Minor differences in the color values for pixels in the image may be present. The actual amount of variance in the color values varies based on the quality of the video capture device and device driver software implementation. This variance in color values is referred to as “noise”. Differences in frames due to noise make it impossible to do a simple bit by bit comparison between two frames to test for motion. Instead, a motion detection method is utilized. Motion detection methods preferably are video hardware independent and detect cases where even a small amount of motion exists between two frames without triggering false positives due to noise.

According to one embodiment of a motion detection method, network traffic is reduced by not requiring clients to send video frames unless motion is detected. This allows the software to run even on networks with a small amount of bandwidth.

According to one embodiment, the user-side camera system remembers the bitmap data for the last frame that was sent to an XML Router. Remembering the previous frame is necessary because in order to execute a motion test, the method needs two frames to compare against each other—the last frame that was sent to the server will be compared against frames received from the video adapter to test for motion. When a frame is received from the video adapter, it is first converted from color to a gray scale image. This can be done using standard, publically available techniques that convert RGB values to a luminance value.

A bitmap also is created with the same size as the incoming video frame, which will be referred to as the “motion map”. The motion map will indicate, for each pixel in the frame, whether or not the pixel is still being considered as a possible source of motion. For each pixel in the incoming frame, the method will calculate the difference in luminance values between the incoming frame and the same pixel in the previously sent frame. If this value exceeds the noise threshold then corresponding pixel in the motion map is flagged. This represents the first pass in the motion detection method.

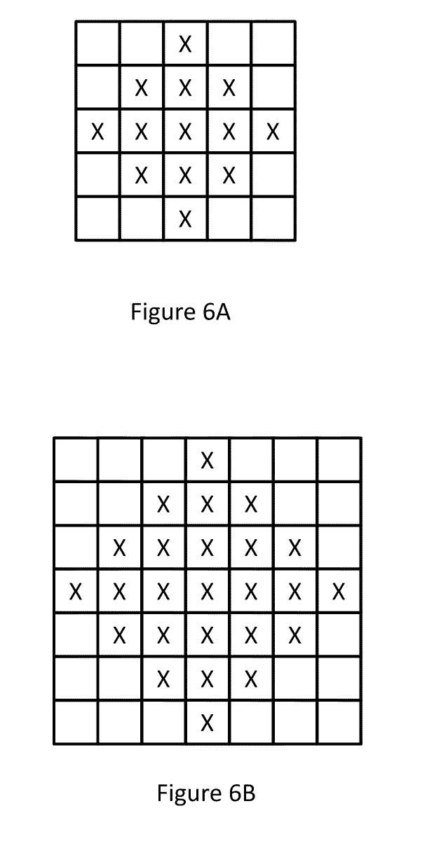

However, if the noise threshold is too low, false positives will be detected. If the noise threshold is too high, true motion will not be detected by the method. To address those issues, a method can look for blocks of pixels in the motion map that have all been flagged for motion. This block of pixels is referred to as the “bloom” because the motion detection technique blooms out in a diamond pattern around the target pixel when testing for motion. The bloom level is configurable (e.g., in a configuration file or software command-line “switch”). A bloom of size 5 is shown in FIG. 6A, where the center X is the pixel that is being considered for motion, and the surrounding X's represent the surrounding pixels in the motion map that must also be flagged for motion in order to keep the target pixel marked as a candidate for motion. Otherwise, the flag for the target pixel in the motion map is cleared, dropping this pixel as a false positive. As shown in FIG. 6B, a bloom size of 7 is also possible, as is a bloom size of 9 (not shown) or any other assigned value.

The method scans the entire motion map, applying the bloom processing from top-left to bottom-right. This means that the range of pixels considered is actually smaller than the size of the bitmap, because it is impossible for a pixel in the corner of the bitmap to pass the bloom test. Therefore, to improve performance, the process only tests pixels with sufficient area surrounding them to pass the test. For example, with a size 5 bloom, and a bitmap coordinate system that begins in the top left with (0,0), the scanning would begin at (2,2). The process looks at the target pixel in the motion map. If the pixel was flagged for motion in the previous step, the bloom test is applied. If the pixel fails the bloom test (meaning not all surrounding pixels in the bloom area were also flagged in the motion map), then the pixel's flag is cleared. If the pixel passes the bloom test, the entire square area surrounding the pixel is flagged in the motion map—meaning that the corner areas surrounding the diamond are flagged for motion as well, if they were not flagged already. The method continues moving through the motion map left to right, top to bottom, applying this logic to each pixel.

With a bloom size set to a value larger than 3, the process is able to use a relatively low value for the noise threshold. This allows for even small amounts of motion to be detected without triggering false positives. With a low noise threshold, many pixels are flagged as candidates for motion in the first pass, but are disregarded in the second pass bloom test unless all of the surrounding pixels were also flagged for motion.

The process also can dynamically adjust the noise threshold. The process attempts to maintain a noise threshold value that results in 25% of the pixels reporting motion at any given time. Even with 25% of the pixels reporting potential motion, the bloom test is able to reliably eliminate false positives. The process recalibrates the value for noise threshold once every second. It does this by testing to see what percentage of the pixels were flagged during the first pass. The noise threshold will be adjusted up or down based on how the current percentage compares to the target percentage. If the current percentage is greater than the target percentage, the noise threshold is increased by one, and if the current percentage is less than the target percentage, the noise threshold is decreased by one. The noise threshold is never adjusted by more than one unit at a time, and the recalibration happens only once per second. This prevents rapid swings in the noise threshold value during periods of motion. Additionally, the process will defines a minimum and maximum noise threshold values (e.g., 4 and 85, respectively) and prevents the noise thresholds from being adjusted beyond those values. The noise recalibration feature of the process helps the process to remain accurate as conditions viewed by the video device change over time. For example, for many video devices, noise levels increase as the captured image becomes darker. This is particularly important for cameras that capture images outside or in rooms where the lights may be turned on or off.

The process counts the number of pixels that passed the bloom test and compares this count against a threshold value, which also is configurable (e.g., 8). If the number of pixels that passed the bloom test meets or exceeds this threshold, the process concludes that motion was detected in this frame.

The process contains several values that can be tuned to affect the process's performance. These values may be changed (e.g., by a system administrator) later to improve the process's performance. Exemplary values are shown in the table below.

| Parameter Name | Parameter Value | Description |
|---|---|---|
| Min. Noise Threshold | 4 | Minimum noise threshold value |
| Max. Noise Threshold | 85 | Maximum noise threshold value |
| Target Percentage | 25% | The process will adjust the current noise |
| | | threshold value to attempt to consistently see |
| | | cases where this percentage of the pixels |
| | | exceed the noise threshold when comparing |
| | | current frame to previous frame |
| Recalibration Frequency | Every Second | How often the process adjusts the noise |
| | | threshold value |
| Bloom Size | 9 | The size of the “bloom” used to filter out false |
| | | positives |
| Threshold | 8 | The minimum number of pixels that must have |
| | | passed the bloom test for this frame to be |
| | | considered as having motion |

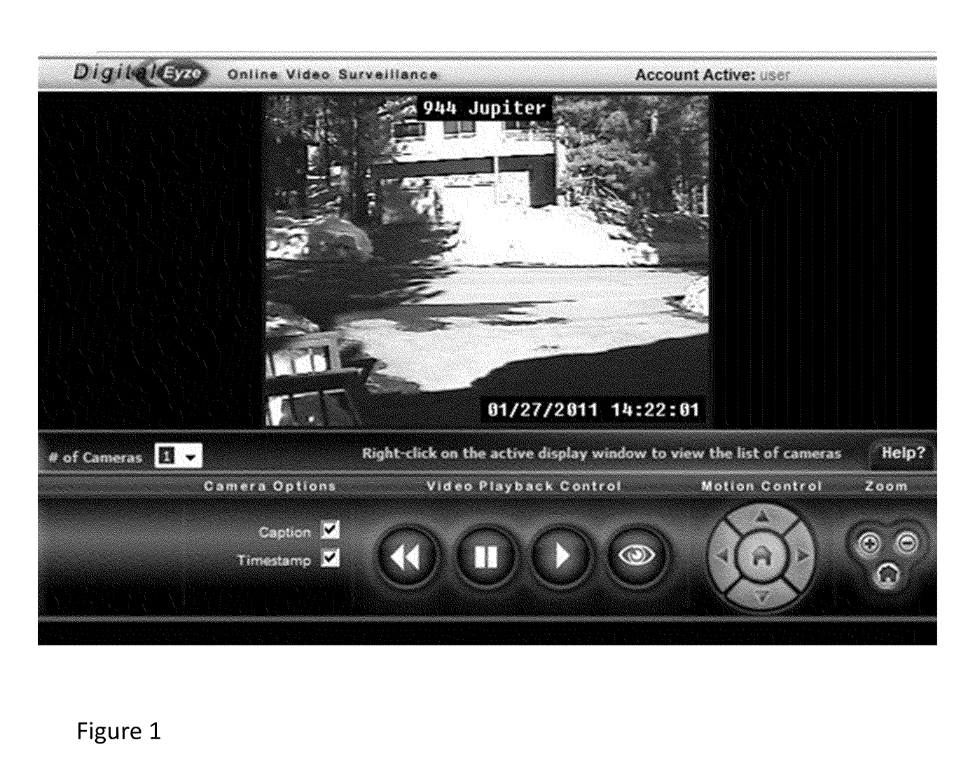

In a preferred embodiment, once the video streams have been established between at least one camera and the data management facility, the user may access the recorded data from any one of several interfaces. As shown in FIG. 1, a first data retrieval interface comprises a World Wide Web browser that connects to a server associated with the data management facility. The user authenticates itself to the server and is provided a list of available cameras from which he/she can obtain video. The number of cameras and their sources that can be seen can be configured on a user-by-user and client-by-client basis. Thus, some cameras may be available to only one user while other cameras may be accessible to multiple users. The user authentication can also specify what kinds of video data a user can see and what he/she can do with that video data. For example, some users may only be able to see delayed live feeds, and others may be able to control the feed (e.g., rewind, pan, zoom). Also, some users may be allowed to download stored video while others may not.

Once at least one camera is selected, the user begins to see video from that camera. To receive the video, the browser may be supplemented with one or more active components (e.g., an ACTIVEX, JAVA, ADOBE FLASH or SILVERLIGHT user interface control, as well as JAVASCRIPT programming language instructions). The video may be either the most recently received video, thereby forming a time-delayed live feed (as the video is first received from the remote source and then sent to the interface), or it may be recorded video data from earlier in the day or from a previous day. Video feeds using web browsers is a known technology in the area of traffic cameras in several metropolitan areas. For example, trafficland.com provides such a service for monitoring cameras in the Washington, D.C. area.

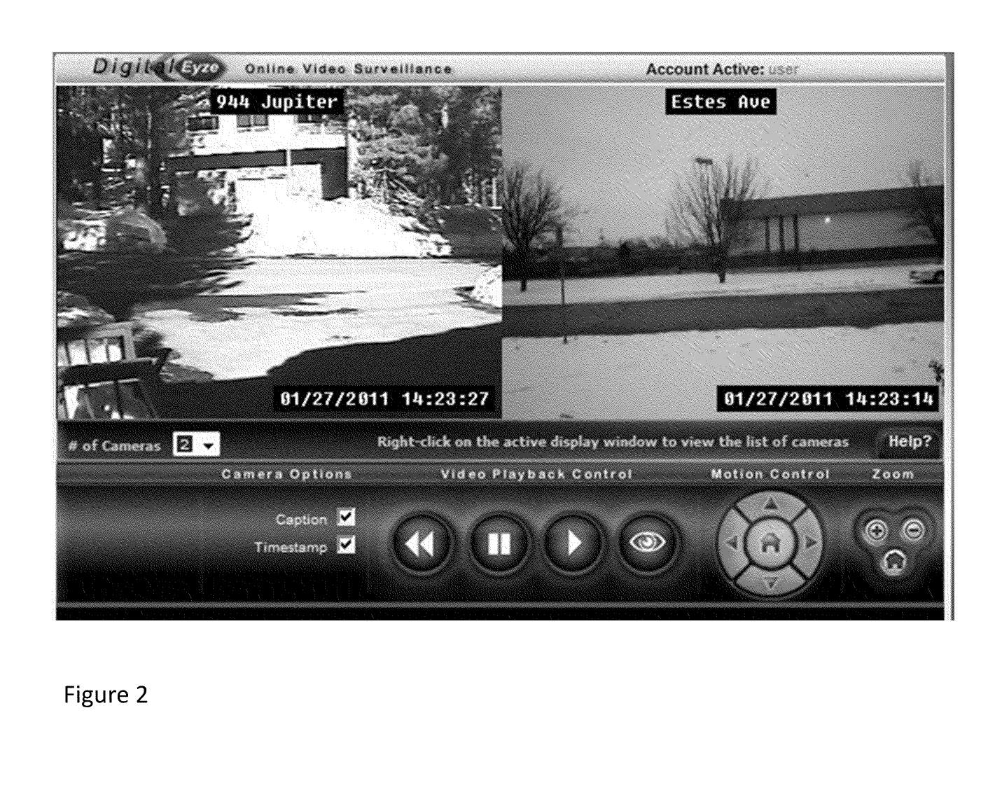

To facilitate an examination of what is happening in a site with multiple cameras, the interface preferably includes the ability to select video from multiple sources simultaneously. Thus, as shown in FIG. 2, the video can be displayed in a matrix of sub-windows inside a browser where the user selects which cameras of the available cameras are to be displayed. Optionally, the user may be able to specify the order and placement of the cameras within the matrix (e.g., in order to get different views of the same area in close proximity to each other). Each sub-window operates independently of the other sub-windows in the matrix and can be used to view video from any of the cameras available to the user. The same camera feed could be displayed in more than one sub-window in the matrix if desired. For example, the user could choose to view the live feed from a camera in one sub-window in the matrix while simultaneously viewing recorded view from the same camera in another sub-window, or to show a digitally zoomed in view of a camera feed in one sub-window while simultaneously displaying the full view of the same camera feed in another sub-window.

The interface may provide the ability to superimpose the camera name and/or a date and time stamp on top of the video image being displayed, as shown in FIG. 2. The interface may provide the user with a method to enable or disable these features individually for each video display sub-window in the window matrix (e.g., check boxes). When the date and time stamp is activated, the date and time will be automatically converted to and displayed in the user's current time zone format, even if the video feed originates from a camera located in another time zone.

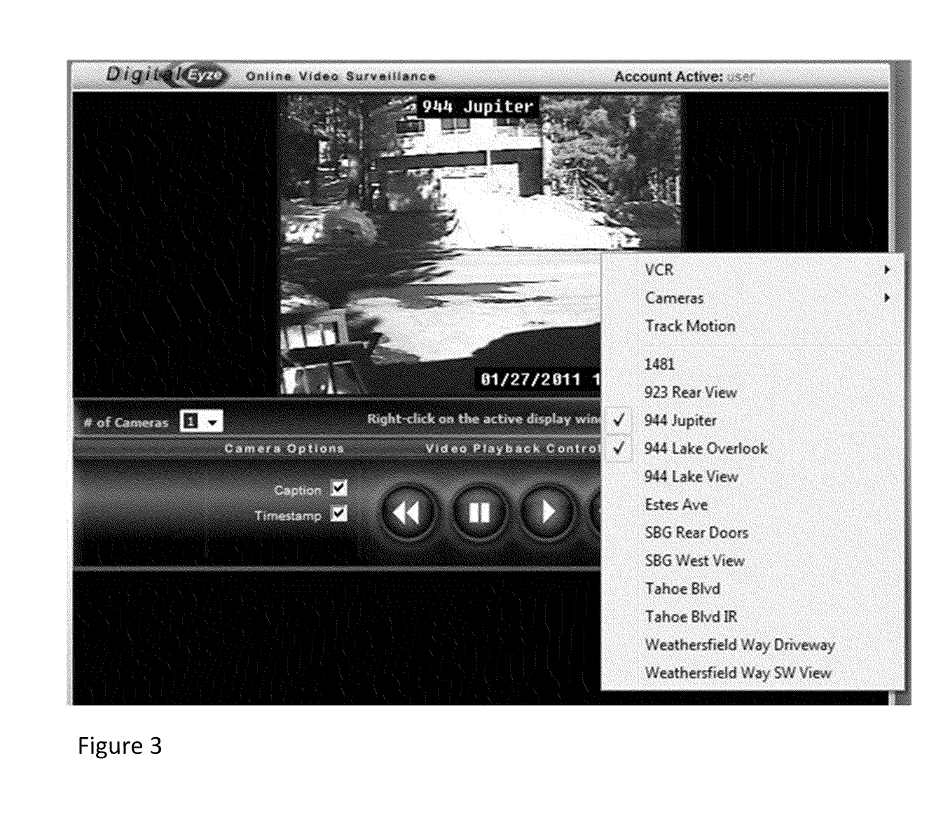

In addition to using multiple windows to view different sources simultaneously, the interface can further enable any one of the windows to rotate between sources. As shown in FIG. 3, a list of sources may be displayed upon request (e.g., by right clicking on the video window). To rotate between two sources (e.g., “Tahoe Blvd” and “Parking Lot”), the user would select both sources (and may be provided confirmation of the selection by a check mark appearing next to the selection). As further shown in FIG. 3, sources may be non-live video sources such as VCRs or digital video recorders (DVRs).

In addition to delayed live feeds, the user's interface may include, but is not limited to, a series of controls to pause the feed, reverse the feed, and return the feed to the delayed live feed. A user interface that provides the ability to display multiple video feeds simultaneously using a matrix of sub-windows can allow the user to apply these feed control options to one video feed without affecting changes to the other sub-windows displayed in the matrix (e.g. rewind one video feed while continuing to view live video from the other stream displayed in the matrix). Furthermore, the user interface may also include an input area for specifying a time of day for a particular day that the system should rewind to (e.g., to see the cause of an alarm).

The system may further include a user interface that is integrated with or runs on a cellular telephone. Video may be delivered to the cellular telephone by utilizing a web browser thereon, using a combination of active languages or controls (e.g. an ACTIVEX, SILVERLIGHT, FLASH, or JAVA user interface control, as well as JAVASCRIPT programming language intructions), or through an application built to run on the cellular telephone's native application development platform. The phone may either receive an actual stream or may make a series of rapid, successive requests for parts of the recorded or delayed video which grab a sufficient number of frames per second to achieve the appearance of a stream.

In yet another embodiment, TABLET PCs and other portable computing devices (e.g. APPLE IPAD, APPLE IPOD, WINDOWS TABLET PC, ANDROID TABLET PC, WINDOWS CE and cellular telephones) are used to connect to the data management facility. The user interface may be exposed by utilizing a web browser thereon, using a combination of active languages or controls (e.g. an ACTIVEX, SILVERLIGHT, FLASH, or JAVA user interface control, as well as JAVASCRIPT programming language instructions), or through an application built to run on the portable computing device's native application development platform.

The user interfaces may further be supplemented with user interface controls for remotely controlling the operation of the camera. For example, the cameras may be controlled to zoom in or out, pan and tilt (e.g., using buttons for those functions or gestures on touch screen interfaces supporting gestures). Such control may result in actual physical movement of the camera, if it is supported, or may be achieved virtually, if supported. For example, a camera can appear to pan right and/or left by performing a virtual zoom (i.e., enlarging one area of an image without actually changing the focus) and then moving to the right or left of the actual image and enlarging the new virtually zoomed image. Physical movement of a camera would affect the video stream provided by the camera to all users subscribed to the video feed. However, a user could apply a virtual zoom to a camera feed, enlarging the user's video of the camera feed, without affecting the video feed displayed to other user's subscribed to the video feed.

In addition to the playback of video, the interface may further provide the ability to specify a portion of a previously recorded stream that should be downloaded to the user's computer (or phone). The downloaded file may be in any format (e.g., MPEG, MPEG-2, MPEG-4, WINDOWS MEDIA PLAYER). Because video encoding is a time consuming operation, the user interface may allow the user to request that a video file be created and then continue with other tasks while the video file is generated in the background by the data management server. The data management server will provide the user with a notification (e.g., email or SMS text message) informing the user that the video file is available for download with the message including, for example, a link to the created video file or instructions on how to access the file.

Because the video data may contain sensitive information, the video data is preferably encrypted along each of the transmission links. Thus, from the camera to the data storage facility the video data would be encrypted. Likewise, from the data storage facility to the user's playback device the video data would be encrypted.

The cameras, the computer connected to the cameras, or the data storage facility may additionally provide a motion sensing service such that a user is notified of motion in an area where none is expected. For example, no motion is expected in a locked warehouse, so if motion occurs, then the user could be notified by a specified communications mechanism (e.g., by email, phone, cellular phone, pager, etc.). If supported by the notification delivery method, the system may include additional details (e.g., attached video clip of the incident, or web hyperlink to allow user to quickly connect to the server and review).

When an organization (e.g., a company) wishes to record from more than one location or to provide access to recorded video to more than one person, various account provisioning controls may be added to the above-described system. For example, multiple accounts can be stored on one or more centrally managed computers to which an organization can be given access. The video streams of a first organization can then be stored separately from the video streams of a second organization such that only those persons authorized by the first organization can get access to the video streams associated with the first organization's account. Similarly, only those persons authorized by the second organization can get access to the video streams associated with the second organization's account. In an embodiment where the recording facility can record and pass on a live stream simultaneously, a manager of an organization may be reviewing a recorded stream while a supervisor is watching a live video; however, neither the manager nor the supervisor need be at the location where the video is being recorded from nor at the same location as each other. (The users can authenticate themselves to the system using known authentication methods (e.g., username/password, RSA SECURID).)

The account of an organization may also include the threshold information that controls the amount of data that can be stored and/or played back for that account, as well as the number and/or types of actions that may be generated. For example the number of streams that can be recorded simultaneously by an account may be limited or the amount of video (e.g., megabytes/hour) may be limited. Similarly, amount and length of video streams as well as the replacement policy may be controlled for an account. For example, an account may be configured to purge old video streams based on a selected replacement policy (e.g., a first-in-first-out erasure method) or based on location specific information (e.g., erase recordings from camera A before erasing recordings from camera B). Likewise the number of simultaneous viewer requests for streams associated with an account or organization may be limited. Likewise the number and type of generated actions may be defined or limited (e.g., generate notification e-mails but do not activate on-premise alarm lights or sirens) based on association with a defined subscription type. Such thresholds serve to limit the system's incoming bandwidth utilization, outgoing bandwidth utilization, storage space (hard drive) utilization, and business liability on an account-level. The system also need not utilize the same threshold levels for all organizations. For example the first organization may pay a higher price for 5 incoming streams, 3 outgoing streams, 300 GB of storage space, and on-premise alarm activation while a second organization may pay a lower price for 3 incoming streams, 1 outgoing stream, 100 GB of storage space, and basic e-mail or SMS text alerting.

In order to reduce bandwidth and storage utilizations, the transmitting adapters can be configured to implement a motion sensing procedure or method, switching to a mode where frames are only sent at a specified interval during times of non-activity, as described in greater detail herein. The system can further be configured to programmatically throttle the adapters which transmit live video streams into the system. In keeping with the above discussion on account-level configurations, the system may provide throttling at an account level such that an amount of data transmitted to the system by all cameras associated with an account does not exceed the threshold level for the account. In a condition where the video received for the account exceeds the threshold, the system can send one or more messages to the cameras associated with the account to request that video be sent at a lower level. The cameras can then be configured to return to the original level if the cause for the increased level is addressed. For example, if an account has four cameras associated with it and the cameras are each transmitting at a medium resolution, motion at a first camera may cause the need for higher resolution images from the first camera, and the first camera may begin transmitting higher resolution images (or more frequent images). However, if the combined bandwidth of the four cameras exceeds the receiving bandwidth threshold, then the other three cameras may be sent messages by the system to instruct them to transmit at a next lower resolution (e.g., low resolution being the next lower resolution from medium resolution) or less frequently (e.g., 10 frames per second (fps) instead of 15 fps).

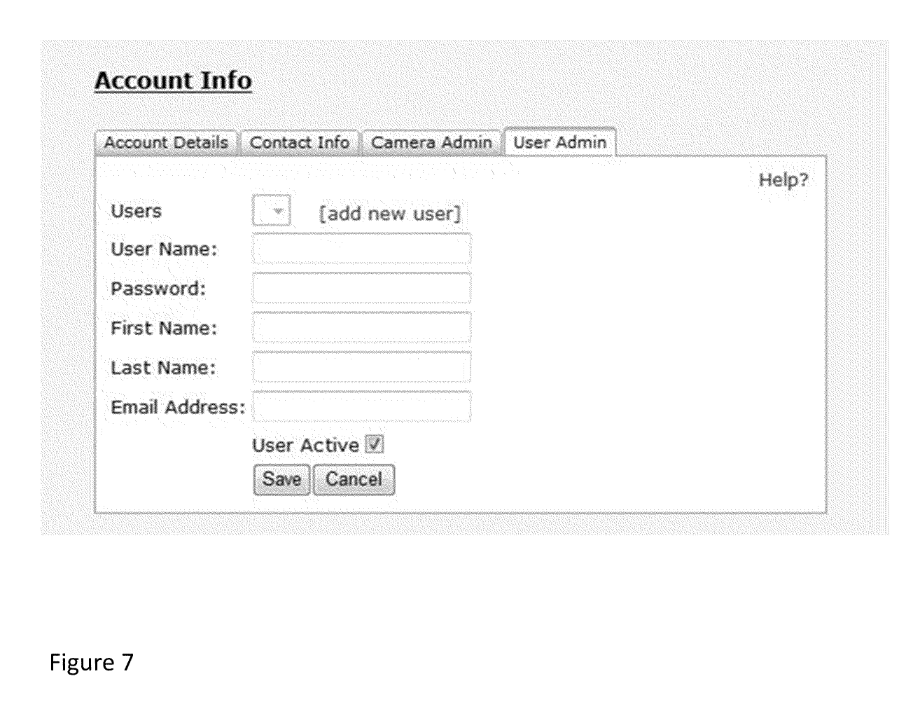

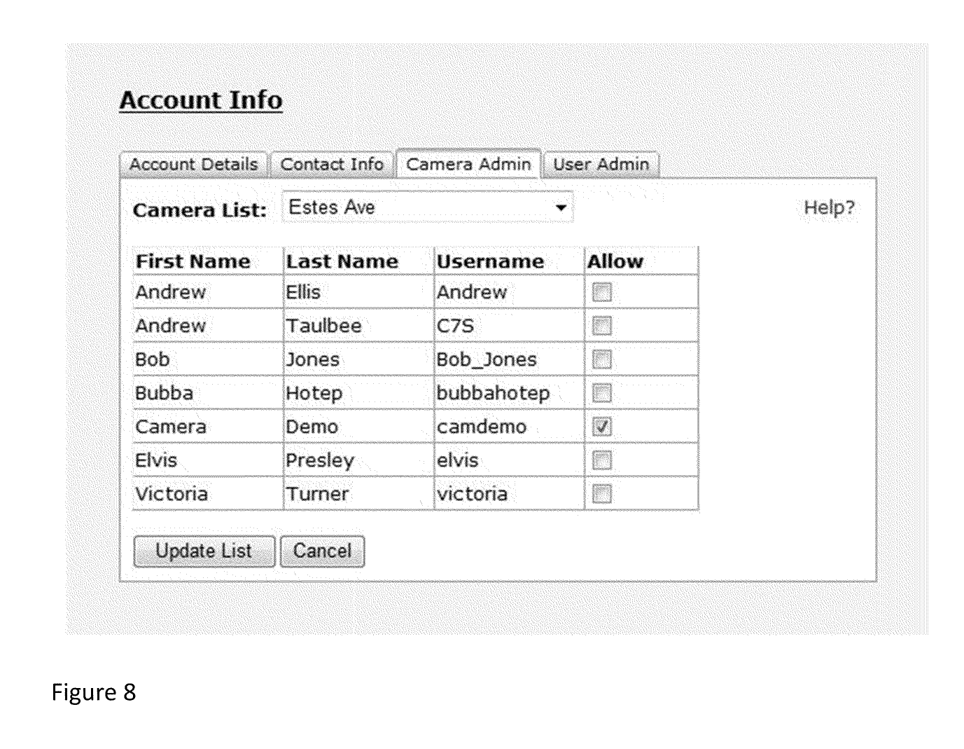

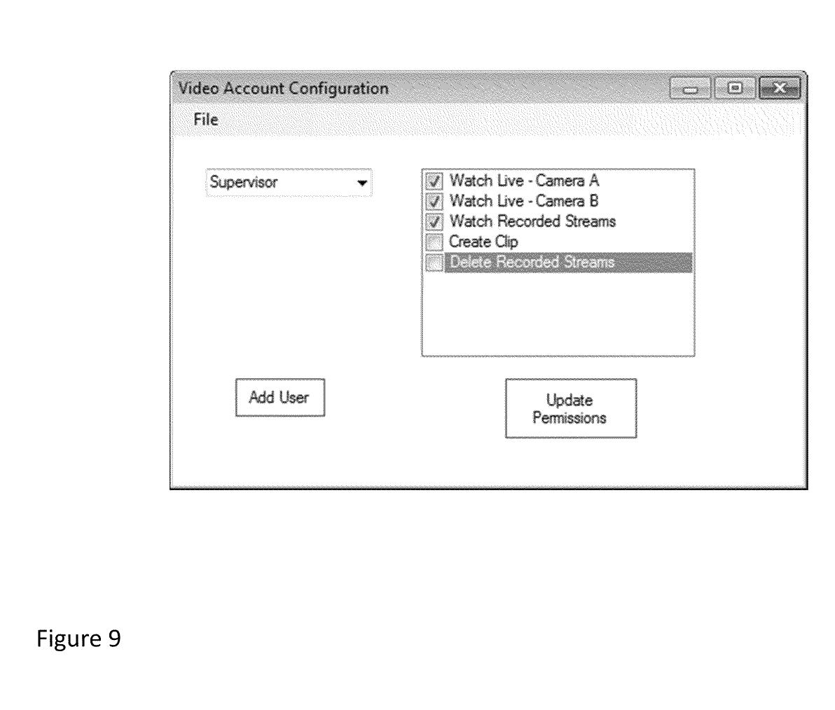

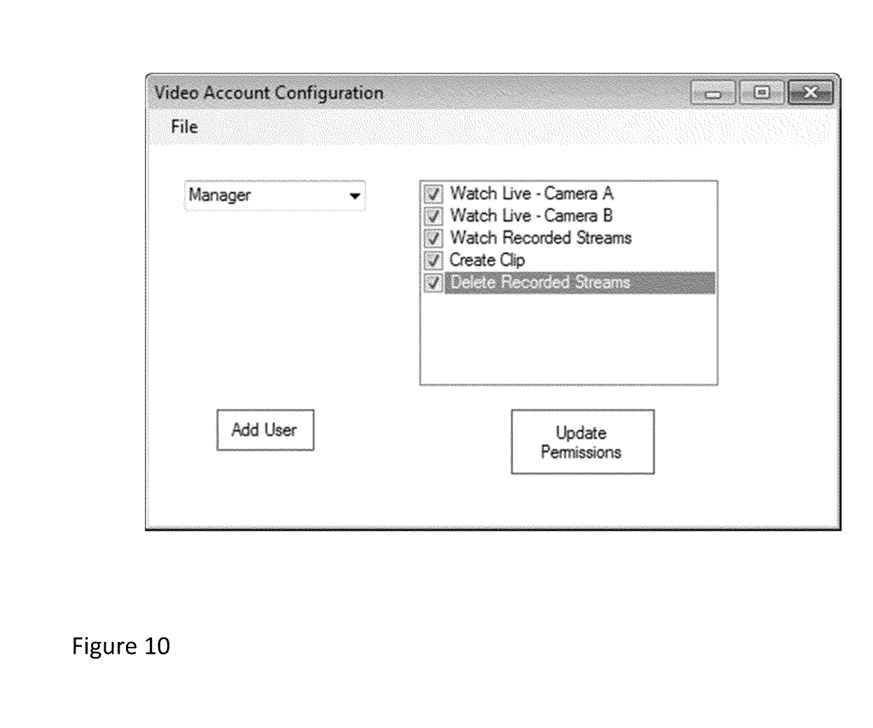

As described above, an organization may require various levels or types of access to video streams associated with the organization. In order to address this, as shown in FIGS. 7-10, an account control system may be provided so that access lists may be associated with an account such that the permissions of various users associated with an account can be specified. For example, an account with four users (e.g., two clerks, a supervisor and a manager) associated with it may have some users which can access the recorded or live video of some cameras that others cannot (e.g., clerk 1 can access camera A and clerk 2 can access camera B, but not vice versa) while some users (e.g., the supervisor and the manager) can access the video from all the cameras. Also, some users may have rights to perform actions on stored videos that others do not. For example, a supervisor may review recorded video from when he/she was on duty but not from other times, and the supervisor cannot delete recorded video. By comparison, a manager's access may be configured to allow all recorded (and live) video to be reviewed, and may even allow video to be erased. (While an application-style interface has been illustrated as an exemplary embodiment, interfaces with similar functionality can be provided using other interfaces, such as World Wide Web interfaces and/or Dynamic HTML interfaces.)

The system may also be configured to allow certain users to access video from particular streams by specifying a time of the video to be viewed. For example, a manager may wish to see the number of people present on the video at the opening or closing of a store or at lunch time. A user with sufficient permissions/rights may then also extract time slices of the recorded video in order to transfer it (e.g., to store it on another medium). For example, if a manager views that a shoplifter has stolen from the store, the manager may tell the system to extract the relevant stored frames of video, to use commonly available encoding software, and store the compiled video file (e.g., an MPEG file, Windows Media Player file, or Advanced Systems Format file). Such a file can be played back with a conventional video player application running on a computer after having been transferred to a third party (e.g., an insurance or police).

As described above, the system can use communication prioritization, and such prioritization preferably controls the flow of data between clients and the data management service. A client connects to the data management service by opening a network connection to the server and passing the required authentication information to the server. The server will validate the information and then, if everything is OK, sets up the session and return a message to the client indicating that the connection was successful.

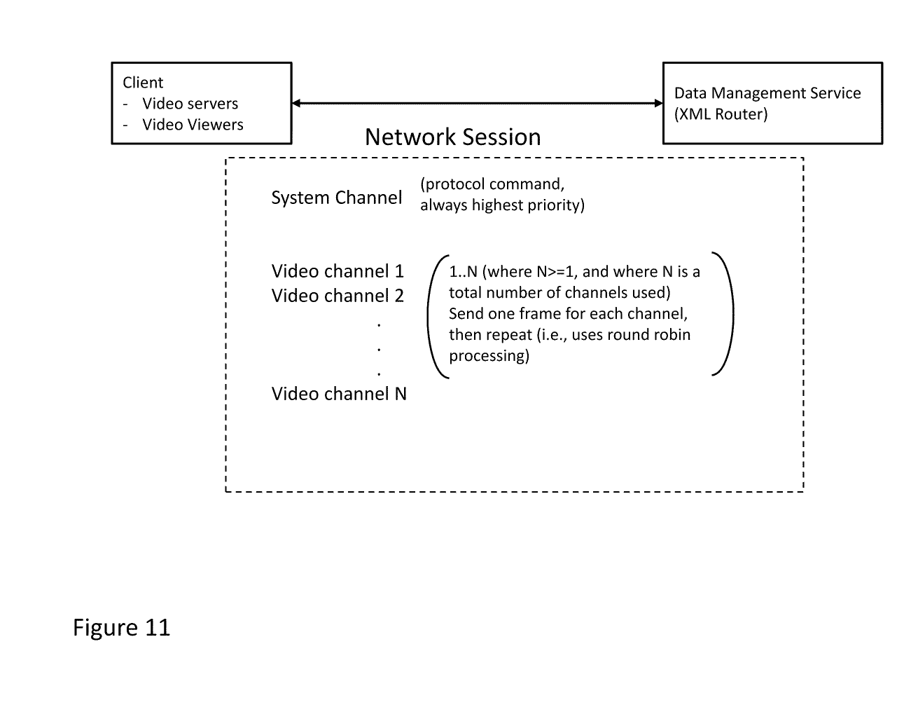

As shown in FIG. 11, a single network session may contain multiple data channels. The first channel is referred to as the “system channel” and is responsible for carrying protocol messages between the client and the server. Traffic in the system channel always has the highest priority. When messages are waiting to be sent across the system channel, pending traffic for all other channels must wait until the system channel data is first processed. This ensures that the client and server can always exchange protocol messages (change operating parameters, notify clients of events and status changes, etc.) even in cases where a large volume of data is being sent across the network.

In addition to the system channel, a client may have a number of additional channels. The infrastructure need not place any limit on the number of additional data channels that can be open between the client and the server, although the data management service will enforce limits on the maximum number of channels based on account subscription levels, network bandwidth limits, etc. Additionally, clients may also support a configuration where only the system channel is active, in cases where no additional channels are required (e.g., video server which has cameras temporarily disabled, or a viewing client that has not yet selected any cameras for viewing).

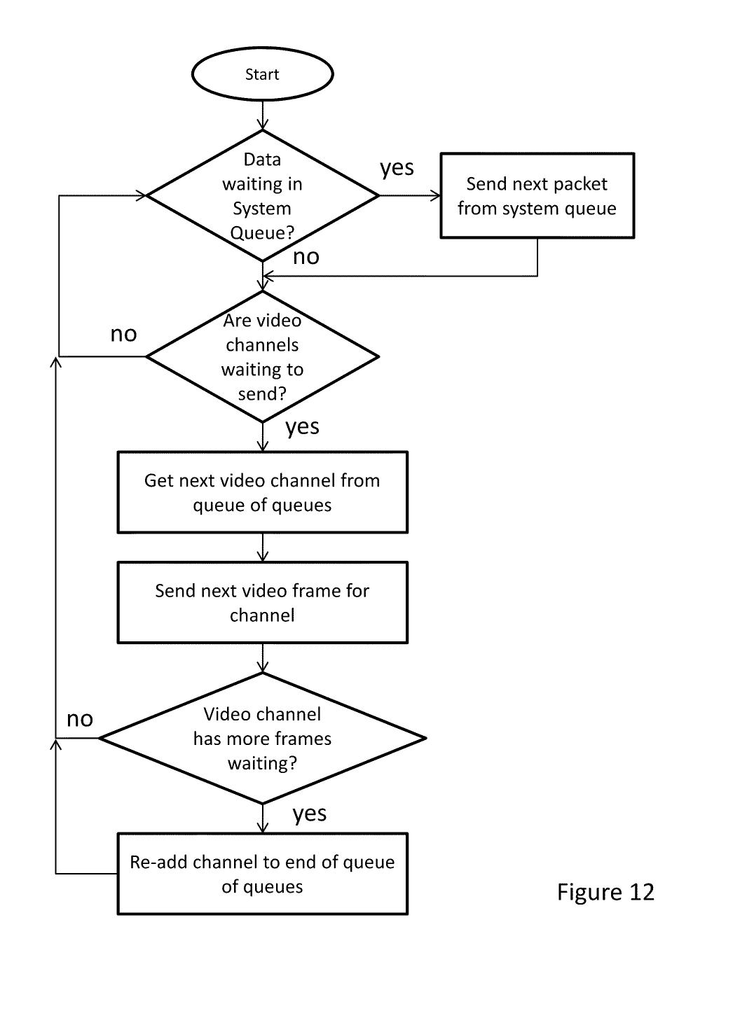

Video traffic between clients and the data management service is sent using a frame-by-frame paradigm. Each video channel can be envisioned as a queue, or a waiting list, of frames waiting to be sent across the network channel. Frames in each video channel queue operate using a “first in, first out” method, meaning that the frame that has been waiting in line the longest will always be the next frame scheduled to be sent across that video channel. Particularly in cases where a client is running over a low-bandwidth network connection, each queue may contain numerous frames of video that are waiting to be sent. For clients that are supporting multiple video channels, it is important that all video channels receive an equal priority. For example, if the client was a two camera video server, data captured from both cameras should be sent to the data management server at an equal rate. If the infrastructure waited until the queue of frames from the first camera was completely sent across the network before processing the pending frames for the second camera, it would result in camera two falling behind “real time”, or, if the bandwidth was severely restricted, possibly never being sent to the server at all. As shown in FIG. 12, to ensure that all video channels receive equal priority, the infrastructure maintains a “queue of queues” identifying all of the different video channels that have one or more frames waiting to be sent. Each of these video channels are “in line” and waiting for data to be sent to the server. When a video channel is at the front of the line, the next frame for that channel is sent to the data management server, and then that video channel is moved to the end of the line. This ensures that traffic for each video channel shares the available network bandwidth equally.

The frame-by-frame paradigm provides a standardized unit of measure that the system can use to control network usage, rather than simply thinking of network traffic in bytes. The frame-by-frame design allows the data management service to dynamically adjust network bandwidth across video channels, while still maintaining a “real time” video link with each camera. For example, if motion is detected on one camera, the data management service may send a request to that camera to switch to a higher resolution to capture more detail, and simultaneously instruct the other cameras to switch to a lower resolution mode, in effect, giving the camera with activity a larger share of the available bandwidth. However, all of the video channels would still receive an equal send priority, so even though the size of the frame from the active camera (and therefore, the bandwidth required) would be larger than the frame size for the other cameras, each video channel would still continue to send frames at an equal rate.

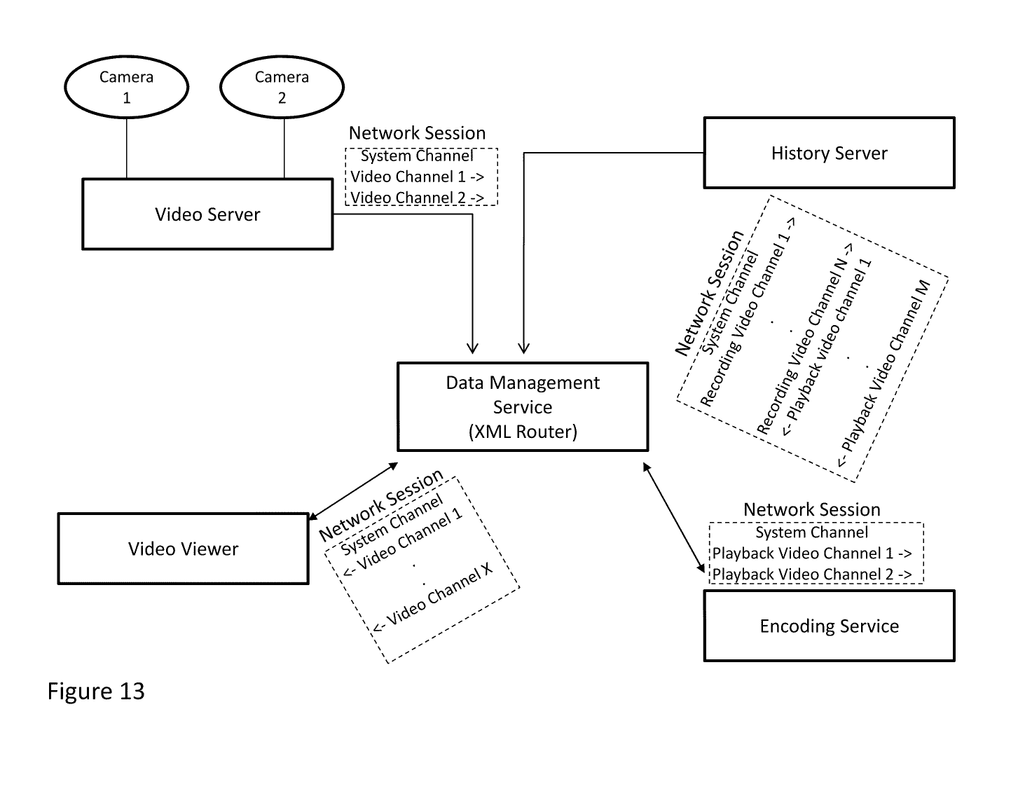

As shown in FIG. 13, the network sessions for the various components in the system can vary between the types of communicating components. As discussed above, a video server may include a system channel and at least one video channel (when at least one camera is active). The video channels are shown with a “->” designation that shows the direction of video flow (i.e., from the video server to the data management service). The history server similarly has a system channel but also can have a number of recording video channels (e.g., 1 to N) (in an in-bound direction) and a number of playback video channels (e.g., 1 to M) (in an out-bound direction), where the number of recording and playback video channels need not be the same. A video viewer also has a system channel and at least one (in-bound) video channel when at least one video feed is active. The Encoding service also includes a system channel and a number of (in-bound) play video channels.

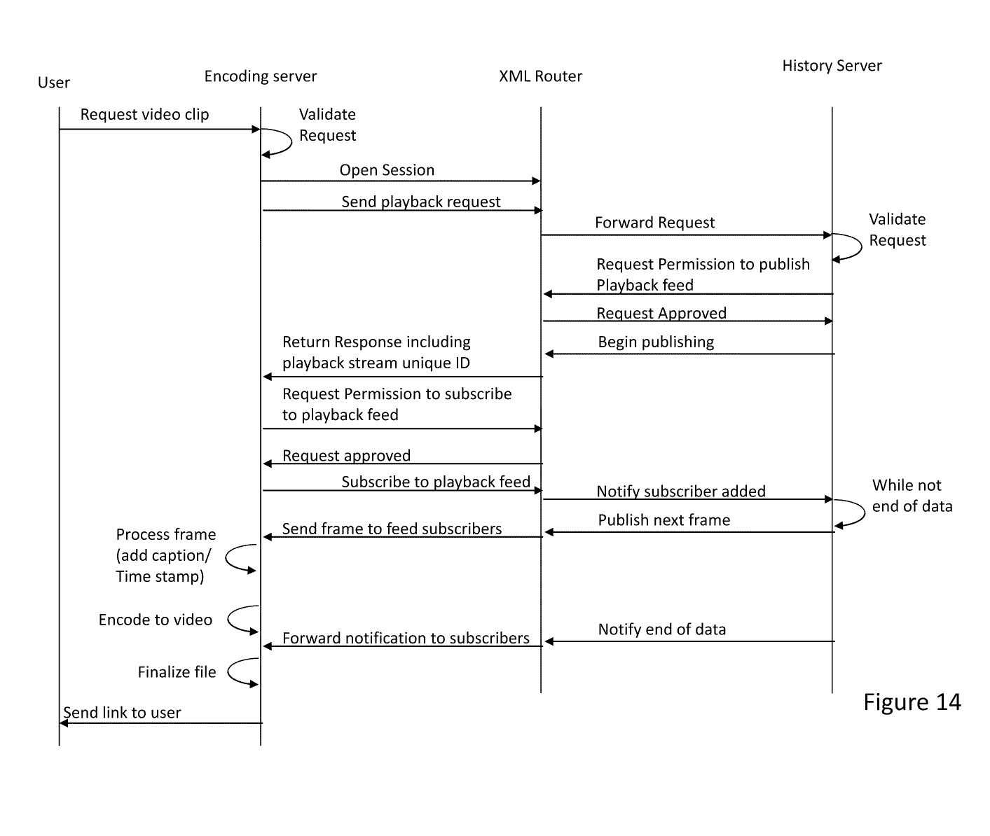

Interactions with the Encoding server are further shown in FIG. 14. In one embodiment, video clips may be generated in a standard video file format (e.g., an MPEG file, Windows Media Player file, or Advanced Systems Format file) such that clips can be played back with a conventional video player application running on a computer after having been transferred to a third party (e.g., an insurance or police). In one such embodiment, this encoding functionality is provided by an encoding service, which is a client connected to the data management service. As shown in FIG. 14, when the encoding service receives a request to create a video clip, it will first validate that the request, and then opens a connection to the data management service. The encoding service will send a playback request, including information about the desired camera, start, and end time for the video clip to the data management service. The data management service will forward this request to the software/hardware responsible for providing video history recording and playback services in the system. The history service begins publishing a playback feed upon receiving the playback request, at which time a response will be returned to the encoding service indicating that the requested playback feed is available. The encoding service will subscribe to the playback feed, and will begin receiving frames of video through the subscription.

In one implementation, the video encoding service applies a pre-processing procedure to the video frames, superimposing a video caption containing the name of the video camera, as well as a timestamp. Because video provider implementations may choose to publish frames based on activity/motion detection, rather than at a consistent frames-per-second (fps) rate, the encoding service will be responsible for calculating the period of time that each video frame shall be displayed when playing back the encoded video file. Implementations that choose to superimpose timestamp data on top of the video frames may need to generate multiple output frames from the one source frame provided by the history service to provide a constantly running timestamp in the video output file. An implementation may use standard methods/existing libraries to encode the video data into a standard video file format and write this file to disk.

After encoding is complete, an implementation may provide a notification mechanism to inform the user that the video file is available for download (e.g., by sending a link, such as a URL, to the user). Such notification methods may include, but are not limited to, Email, SMS text message, instant messaging, pager, etc.

For delivery methods that support it, an implementation may provide the user with an encrypted, direct download link to the video file. The encrypted link provides the user with direct access to the video file without requiring a system log in, and prevents users from editing the link or otherwise tampering with the link to attempt unauthorized access to other files.

The data management service also may provide a threshold that defines how long each video clip that is generated should remain available for the user to download. This threshold may vary on a customer, account, or video adapter level. Implementations should provide a mechanism to periodically review generated video clips and automatically remove files that are older than the threshold defined by the data management service.

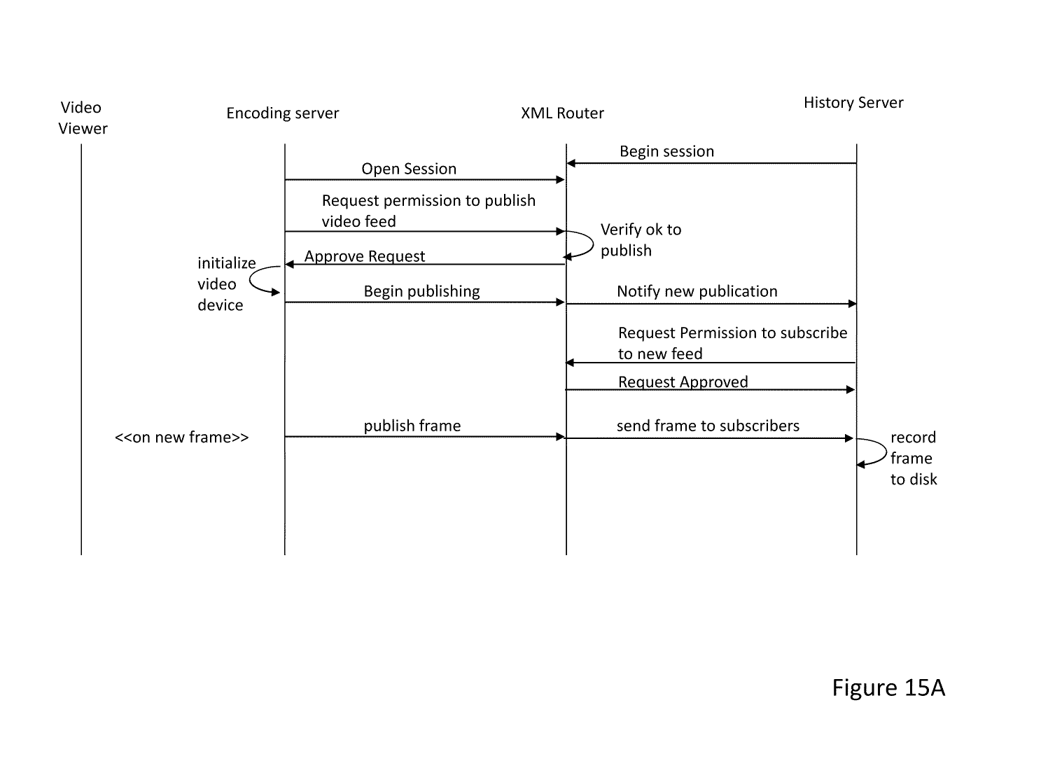

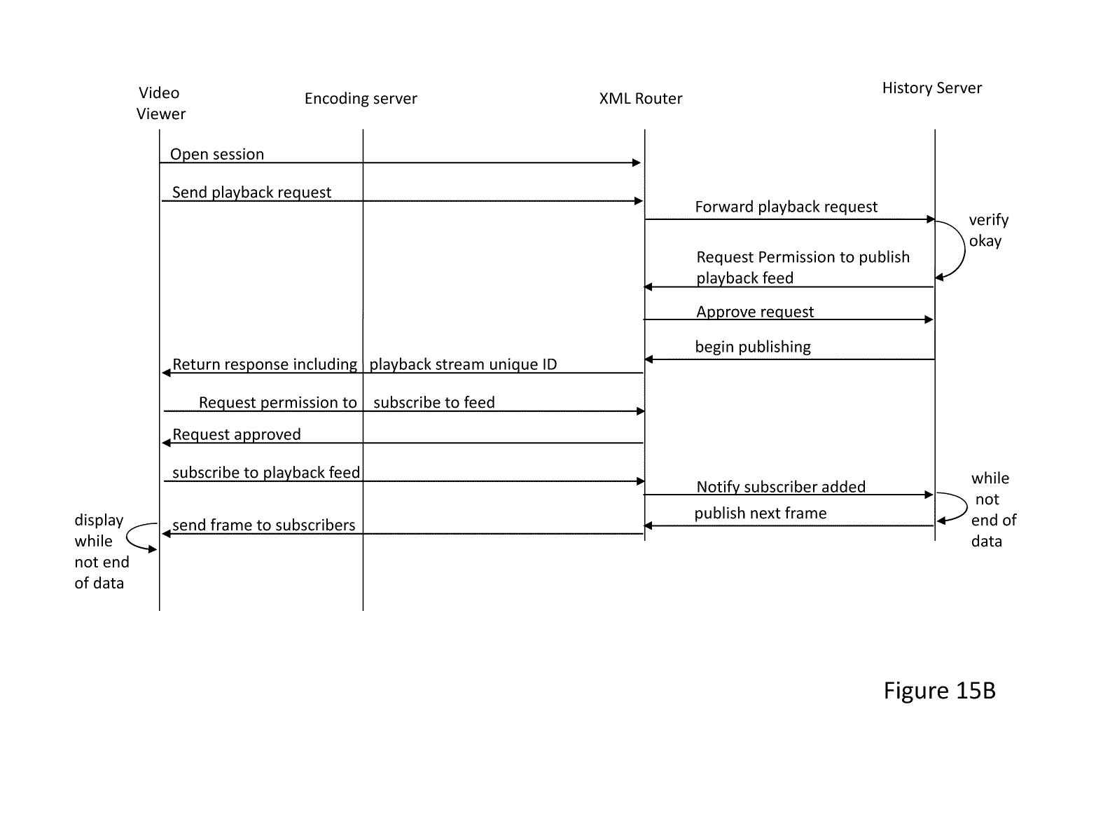

As shown in FIGS. 15A and 15B, in one embodiment, video recording and playback is controlled by a video history service. The history service is a client connected to the data management service that runs under an administrative account that allows access to all published video feeds. The history service requests a list of all published feeds from the data management service, and subscribes to all available feeds. As shown in FIG. 15A, as each feed publishes new frames of video, the frames are delivered by the data management service to the video history service provider. The history service records each frame to permanent storage (e.g., hard drive or storage array), along with metadata associated with the video frame (identifier for the video feed that published the frame, date/time stamp when the frame was taken, etc.)

An implementation of the video history service may use any method to store the data (indexed file system, relational database, etc.) provided that the storage mechanism used includes the ability to quickly seek to a range of frames to be retrieved while simultaneously continuing to record incoming data from other live feeds. The storage mechanism must also provide the ability to store metadata in addition to the frame itself, and provide the ability to delete video frames that are older than the threshold defined by the data management service that controls how long a customer's video should be kept. The threshold may vary on a per-customer or per-video adapter level.

As shown in FIG. 15B, when a video viewer sends a video playback request to the data storage service, the data storage service will forward this request to the video history service. The history service will confirm that the request is valid, and then ask the data storage service for permission to publish a new video feed. When the data storage service approves the request, the history service will begin publishing the playback feed, and a response to the original request will be returned to the video viewer client indicating that the playback feed is now available. The video viewer client will subscribe to the playback video feed in the same manner as it would subscribe to any other feed available to it through that data management service. When the subscription occurs, a notification is sent to the history service informing it that a subscriber has attached to the playback feed. At this point, the history service begins loading frames of video from storage and publishes them, frame by frame, to the data storage service. Publication will continue until the history service reaches the end of the data, as defined by the date range provided by the user. The history service then ceases publication, and the video viewer is notified that no more data is available.

Obviously, numerous modifications and variations of the present invention are possible in light of the above teachings. It is therefore to be understood that, within the scope of the appended claims, the invention may be practiced otherwise than as specifically described herein.

1. A system for remote storage and playback of video data recorded at plural remote sites, the system comprising:
a first communications adapter for receiving streams of live video data recorded at the plural remote sites and for receiving requests from users for interactions with the streams of live video data recorded at the plural remote sites;
data storage devices for storing the streams of live video data recorded at the plural remote sites;
a command interpreter for controlling playback of the streams of live video data recorded at the plural remote sites;
a second communications adapter for playing back the streams of live video data recorded at the plural remote sites; and
an account control system for controlling access to the streams of live video data and to the recorded video data on a per-user basis.

2. The system as claimed in claim 1, wherein the first and second communications adapters are the same communications adapter.

3. The system as claimed in claim 1, wherein the first and second communications adapters are different communications adapters.

4. The system as claimed in claim 1, wherein the streams of live video data recorded at the plural remote sites comprises encrypted streams of live data.

5. The system as claimed in claim 1, wherein the command interpreter controls the streaming of the streams of live video data recorded at the plural remote sites to achieve at least one of pausing, rewinding and fast forwarding the streams of live video data recorded at the plural remote sites.

6. The system as claimed in claim 1, wherein the account control system comprises an access control list for specifying permissions on a per-user basis.

7. The system as claimed in claim 1, wherein the account control system controls whether a user can access a stream of live video data from a specified camera.

8. The system as claimed in claim 1, wherein the account control system controls whether a user can extract a clip from the recorded video data.

9. The system as claimed in claim 1, wherein the account control system controls whether a user can delete a recorded stream of video data.

10. The system as claimed in claim 1, wherein the account control system controls the addition of additional users for an account.

11. A system for viewing remotely stored video data recorded at plural remote sites, the system comprising:
a first communications adapter for receiving streams of live video data recorded at the plural remote sites and for receiving requests from users for interactions with the streams of live video data recorded at the plural remote sites;
data storage devices for storing the streams of live video data recorded at the plural remote sites;
a command interpreter for controlling playback of the streams of live video data recorded at the plural remote sites;
a second communications adapter for playing back portions of the streams of live video data recorded at the plural remote sites;
a playback device including (a) a third communications adapter for receiving from the second communications adapter the portions of the streams of live video data recorded at the plural remote sites and (b) a display for displaying the portions of the streams of live video data received from the third communications adapter; and
an account control system for controlling access to the streams of live video data and to the recorded video data on a per-user basis.

12. The system as claimed in claim 11, wherein the first and second communications adapters are the same communications adapter.

13. The system as claimed in claim 11, wherein the first and second communications adapters are different communications adapters.

14. The system as claimed in claim 11, wherein the portions of the streams of live video data recorded at the plural remote sites comprises encrypted live data.

15. The system as claimed in claim 11, wherein the command interpreter controls the delivery of the portions of the streams of live video data recorded at the plural remote sites to achieve at least one of pausing, rewinding and fast forwarding the portions of the streams of live video data recorded at the plural remote sites.

16. The system as claimed in claim 11, wherein the playback device comprises a computer running a World Wide Web browser.

17. The system as claimed in claim 11, wherein the playback device comprises a PDA.

18. The system as claimed in claim 11, wherein the playback device comprises a cellular phone.

19. The system as claimed in claim 18, wherein the cellular phone comprises means for requesting the portions of the streams of live video data recorded at the plural remote sites sufficiently rapidly to simulate a video stream.

20. The system as claimed in claim 11, wherein the account control system comprises an access control list for specifying permissions on a per-user basis.

21. The system as claimed in claim 11, wherein the account control system controls whether a user can access a stream of live video data from a specified camera.

22. The system as claimed in claim 11, wherein the account control system controls whether a user can extract a clip from the recorded video data.

23. The system as claimed in claim 11, wherein the account control system controls whether a user can delete a recorded stream of video data.

24. The system as claimed in claim 11, wherein the account control system controls the addition of additional users for an account.
